(19) United States
(12) Patent Application Publication
(10) Pub. No.: US 2018/0001281 A1
(43) Pub. Date: Jan. 4, 2018

(54) A MIXING UNIT AND A METHOD FOR MIXING

(71) Applicant: Tetra Laval Holdings & Finance S.A., Pully (CH)

(72) Inventor: Tomas Skoglund, Lund (SE)

(21) Appl. No.: 15/537,883

(22) PCT Filed: Dec. 18, 2015
(86) PCT No.: PCT/EP2015/080464

§ 371 Date: Jun. 19, 2017

(30) Foreign Application Priority Data
Dec. 18, 2014 (SE) 1451576-1

(51) Int. Cl. B01F 3/20; B01F 3/12; B01F 13/06

(52) U.S. Cl. CPC B01F 3/2021; B01F 13/06; B01F 3/1207; B01F 2215/0014

(57) ABSTRACT

The present disclosure relates to a mixing unit. In one implementation, the unit may include a low-pressure vessel, a liquid supply system in communication with the vessel via a liquid inlet, a powder supply system in communication with the vessel via a powder inlet, and a discharge system in communication with the vessel via a product outlet. The liquid supply system may include a deaeration system, the powder supply system may include an air separator, and the discharge system may include a pump for increasing the pressure of the mixed product by pumping the mixed product.

This application is the United States national stage entry under 35 U.S.C. §371 of International Application No. PCT/EP2015/080464, filed on Dec. 18, 2015 and published as WO 2016/097278 A1, which claims priority to Swedish Patent Application No. 1451576-1, filed on Dec. 18, 2014. The contents of these applications are each incorporated herein by reference in their entirety.

### TECHNICAL FIELD

The present invention relates to a mixing unit, as well as to a method for mixing. In particular the present invention relates to a mixing unit and a method for mixing powder with fluid, such as water.

### BACKGROUND

Mixing units are used in several different applications, e.g. in order to combine a first flow of a specific compound with a second flow of a different compound. In food processing mixing units may be used for adding powder to a flow of liquid, such as when mixing milk powder with water.

When mixing powders with liquids one important parameter to control is the amount of air, or other gases, present in the liquid and/or the powder. During powder mixing with water, the surrounding air, and the air entrapped within the powder will be mixed simultaneously into the liquid. This may cause formation of air bubbles. Further to this, dissolved air in the liquid may also contribute to the total amount of air bubbles, especially in cases where mixing is performed in a low-pressure environment.

Gas bubbles are generally not desired since such presence may affect the mixing process, as well as further downstream processes such as separator operation etc., negatively. Therefore, one of the main challenges in mixing powders with liquids lies in preventing unwanted air and foaming. Air may be incorporated into a product by mixers with whipping action or when adding ingredients such as powder, which tends to trap air. Air bubbles will rise to the surface in a product and from there they escape. However, if foam-stabilizing ingredients such as protein are present, they will stabilize into foam at the product's surface instead.

Air incorporation may cause major problems in processing and end-product quality. Air in the product may cause increased fouling in heat exchangers, cavitation in homogenizers, and unwanted whey formation in fermented products. In terms of product quality, air in the product can cause oxidation, both during processing and in the package on the way to consumers. Further to this, air incorporation can also lead to significant product losses in production if the air creates large volumes of unwanted foam in mixing tanks and other equipment.

During mixing, time is therefore required for releasing the entrapped air bubbles. This however, may also constitute a significant drawback of current mixing units, since the only possible way for small air bubbles to vanish is by rising upwards to the surface, which normally is a very slow process especially for small bubbles.

Hence, there is a need for an improved mixing unit, as well as an improved method for mixing.

### SUMMARY

An object of the present invention is to provide a mixing unit and a method for mixing solving the above-mentioned drawbacks of prior art solutions.

For example, an object of the present invention is to provide a mixing unit, and a method for mixing, which significantly reduces the formation of air bubbles. By doing so the time required for air bubble diffusion may be significantly reduced.

According to a first aspect, a mixing unit is provided. The mixing unit comprises a low-pressure vessel, a liquid supply system being in communication with the vessel via a liquid inlet, a powder supply system being in communication with the vessel via a powder inlet, and a discharge system being in communication with the vessel via a product outlet. Said liquid supply system comprises a deaeration system, said powder supply system comprises an air separator, and said discharge system comprises a pump for increasing the pressure of the mixed product by pumping the mixed product.

Said deaeration system of the liquid supply system may comprise a throttling point in direct connection with an inlet of the vessel.

The pressure inside the vessel may be less than atmospheric pressure.

The pressure inside the vessel may be equal to steam pressure of water at a temperature range expanding from the product temperature to 10 degrees above the product temperature.

The air separator may be a multi-stage air separator, such that air is separated in sequence by two or more air separators.

The air separator of the powder supply system may comprise a screw conveyor, or a powder cyclone separator having a powder outlet in fluid communication with the powder inlet.

The mixing unit may further comprise a vacuum pump being in fluid communication with the low-pressure vessel and with a gas outlet of the powder cyclone separator.

The mixing unit may further comprise a cooler arranged downstream the pump.

According to a second aspect, a liquid product processing line is provided, comprising a mixing unit according to the first aspect.

According to a third aspect, a method for mixing is provided. The method comprises the steps of providing a flow of liquid from a liquid supply system comprising a deaeration system; providing an amount of powder through a powder supply system comprising an air separator; feeding said flow of liquid and said amount of powder to a low-pressure vessel for mixing said liquid with said powder; and increasing the pressure of the mixed product by pumping said mixed product out from said low-pressure vessel.

### BRIEF DESCRIPTION OF DRAWINGS

Preferred embodiments of the present invention will now be described in greater detail herein below with reference to the accompanying drawings, in which:

FIG. 1 is a schematic view of a mixing unit according to an embodiment, having a deaeration system according to an embodiment;

FIG. 2 shows a mixing unit according to an embodiment; and

FIG. 3 is a schematic view of a method according to an embodiment.

### DETAILED DESCRIPTION

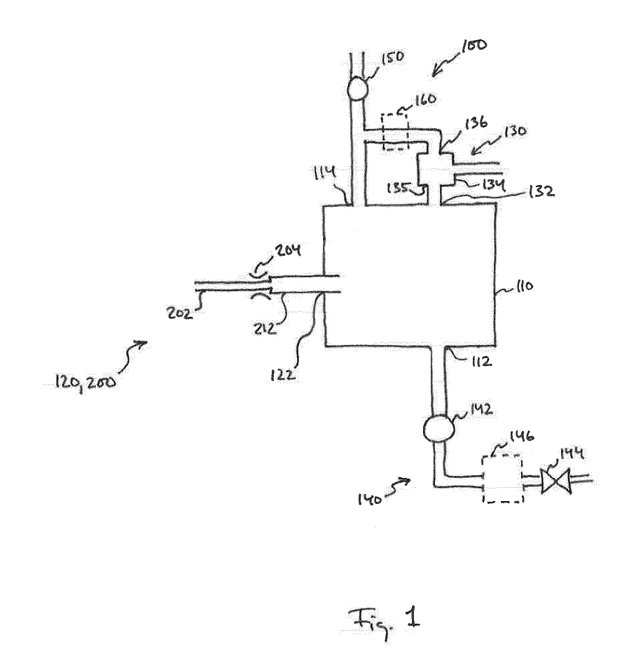

Starting with FIG. 1, a schematic view of a mixing unit 100 is shown. The mixing unit 100 is preferably used for mixing a flow of liquid with a powder additive, such as in liquid food applications. Hence, the mixing unit 100 may be used to add milk powder to water.

The mixing unit 100 may consequently form part of a liquid food processing line, or plant, whereby additional food processing equipment (not shown) may be arranged in fluid communication with the mixing unit 100, either upstream or downstream.

The mixing unit 100 comprises a low-pressure vessel 110, a liquid supply system 120 being in communication with the vessel 110 via a liquid inlet 122, a powder supply system 130 being in communication with the vessel 110 via a powder inlet 132, and a discharge system 140 being in communication with the vessel 110 via a product outlet 112. In accordance with the embodiment described herein, the liquid supply system 120 comprises a deaeration system 200, the powder supply system 130 comprises an air separator 134, and said discharge system 140 comprises a pump 142 for pumping the mixed product under increased pressure.

The low-pressure vessel 110 may enclose various mixing equipment (not shown), such as turbo units with a rotor and a perforated stator in order to ensure an efficient and reliable mixing process. Such mixing equipment is for example known from Tetra Almix In-Line vacuum high shear mixer, which is commercially available.

The low-pressure vessel 110 is in communication with a vacuum pump 150 via an outlet 114, preferably arranged at an upper position of the vessel 110. The vacuum pump 150 is configured to create a very low pressure inside the vessel 110, being close, such as in the neighborhood of 1° C., for example, 0-2° C., to the boiling pressure of the liquid product inside the vessel 110.

The air separator 134 of the powder supply system 132 preferably comprises a powder cyclone separator having a powder outlet 135 in fluid communication with the powder inlet 132 of the low pressure vessel 110. Further to this, the powder cyclone separator 134 has a gas outlet 136 being in fluid communication with the vacuum pump 150, optionally via a flow control valve 160. Hence the vacuum pump 150 will draw gas, such as air, from the vessel 110 as well as from the gas outlet 136 of the powder cyclone separator 134.

The powder is consequently introduced via the powder cyclone separator 134, letting the majority of the carrier air out, while the powder falls down into the mixer/vacuum vessel 110. In certain embodiments two or more separation steps are preferred, realized either by arranging two or more cyclone separators 134 in series, or by circulating the powder over a single cyclone separator 134.

The discharge system 140 is preferably connected to a lower part of the vessel 110, i.e. the outlet 112 is arranged at a vertically low position. The pump 142 is configured to pump out mixed product from the vessel 110 at an increased pressure, such as 3-4 Bar(g). By this the very little remaining air from the mixing will rapidly dissolve into the water, which due to the deaeration of the liquid by means of the deaeration system 200, is very prone to absorbing air into the dissolved state again. A valve 144 is preferably provided downstream of the exit pump 142, and the fluid channel from the pump 142 to the pressure increase point, i.e. at the position of the valve 144, should be long enough for the dissolving kinetics. The distance should preferably be selected such that the time for product to flow this distance is approximately 5-10 seconds. The pressure should preferably be released gently to avoid transition from dissolved state into bubbles again. Such gentle pressure decrease could be provided by means of a pipe having increased inner diameter, over a distance such as 1 meter.

The discharge system 140 may further comprise a cooler 146. If the product is to be cooled after the mixing, it is recommended that the cooling take place just after the pump 142 as the solubility of air is higher the cooler the fluid is.

Still referring to FIG. 1, embodiments of the liquid supply system 120, and in particular the deaeration system 200, will be described in further detail. The purpose of the deaeration system 200 is to ensure that the water, or liquid, used for the mixing is deaerated within the system thereby reducing the air flow into the low-pressure vessel with approximately 3 volumetric % at normal temperature and pressure.

An embodiment of the deaeration system 200 is shown in FIG. 1, which deaeration system 200 has proven to be particularly advantageous for water.

The deaeration system 200 of the liquid supply system 120 has a fluid channel 202 in connection with the low-pressure vessel 110. A throttling point 204 is provided in direct connection with an inlet 212 of the low-pressure vessel 110. The inlet 212 forms a horizontal diffusion and bubble separation channel. Optionally, the fluid channel 202 connects with an intermediate tank, and an exit pump may be provided and arranged in fluid communication with an outlet of the intermediate low-pressure tank. Further to this, a vacuum pump may be connected via a pipe at the top of the intermediate tank for the exhaust gases. A very low pressure may be required for cold water deaeration. The pressure depends on the desired amount of dissolved oxygen, but approximately ΔT≈−5−(−0.5° C.).

The throttling point 204 provides a point of nucleation by a high pressure drop, such as >3.5 Bar. After the throttling point the pressure should preferably remain the same as, or very close to the pressure in the vacuum vessel. Thus the throttling point should preferably—without any further pressure drops due to, e.g., a valve bend or similar—be directly connected to the horizontal diffusion and bubble separation channel, i.e., the inlet 212. Here, further deaeration takes place together with bubble separation. The length of the inlet 212 may depend on the desired performance, but normally it should be within the range of 2-3 m. The diameter is strongly depending on the desired flow rate. The inlet 212 is connected to the vessel 110, or optionally to the intermediate low-pressure tank in which low oxygen equilibrium level prevail by a vacuum pressure close to the pressure corresponding to boiling (ΔT≈−0.5° C.). Thus it is important to control this pressure to be close to boiling, i.e., flash, but without the risk of flashing.

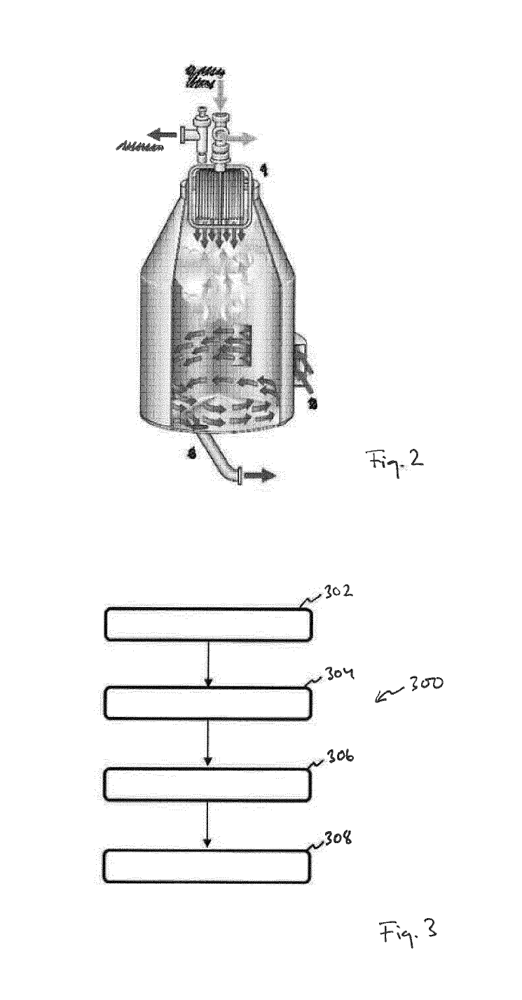

An example of a deaerator 200 is shown in FIG. 2, which deaerator 200 may form part of a mixing unit 100. Pre-heated milk is fed to an expansion vessel, in which the vacuum is adjusted to a level equivalent to a boiling point about 7 to 8° C. below the pre-heating temperature. If the product enters the vessel at 68° C., the temperature will immediately drop to 68−8=60° C. The drop in pressure expels the dissolved air, which boils off, together with a certain amount of the water in the milk. The vapour passes a built-in condenser in the vessel, condenses, and runs back into the milk, while the boiled-off air is removed from the vessel by the vacuum pump.

Now turning to FIG. 3, a method 300 for mixing will be described. The method comprises a first step 302 of providing a flow of liquid from a liquid supply system comprising a deaeration system 200 in accordance with the description relating to FIG. 1. A further step 304 is performed for providing an amount of powder through a powder supply system comprising an air separator in accordance with the description relating to FIG. 1. In step 306, said flow of liquid and said amount of powder is fed to a low-pressure vessel for mixing said liquid with said powder; and the method further comprises the step 308 of pumping said mixed product under pressure out from said low-pressure vessel.

The invention has mainly been described with reference to a few embodiments. However, as is readily understood by a person skilled in the art, other embodiments than the ones disclosed above are equally possible within the scope of the invention, as defined by the appended claims.

1. A mixing unit, comprising:
a low-pressure vessel for producing a mixed product;
a liquid supply system in communication with the vessel for supplying a liquid via a liquid inlet;
a powder supply system in communication with the vessel for supplying a powder via a powder inlet; and
a discharge system in communication with the vessel via a product outlet,
wherein the liquid supply system comprises a deaeration system,
the powder supply system comprises an air separator, and
the discharge system comprises a pump for increasing the pressure of the mixed product by pumping the mixed product.

2. The mixing unit according to claim 1, wherein the deaeration system of the liquid supply system comprises a throttling point in direct connection with an inlet of the vessel.

3. The mixing unit according to claim 1, wherein the pressure inside the vessel is less than atmospheric pressure.

4. The mixing unit according to claim 3, wherein the pressure inside the vessel is equal to steam pressure of water at a temperature range between the mixed product temperature and 10 degrees Celsius above the mixed product temperature.

5. The mixing unit according to claim 1, wherein the air separator of the powder supply system comprises a multi-stage air separator.

6. The mixing unit according to claim 1, wherein the air separator of the powder supply system is a screw conveyor.

7. The mixing unit according to claim 1, wherein the air separator of the powder supply system comprises a powder cyclone separator having a powder outlet in fluid communication with the powder inlet.

8. The mixing unit according to claim 7, further comprising a vacuum pump in fluid communication with the low-pressure vessel and with a gas outlet of the powder cyclone separator.

9. The mixing unit according to claim 1, further comprising a cooler arranged downstream the pump.

10. A liquid product processing line, comprising:
a mixing unit according to claim 1.

11. A method for mixing, comprising:
providing a flow of liquid from a liquid supply system comprising a deaeration system;
providing an amount of powder through a powder supply system comprising an air separator;
feeding the flow of liquid and the amount of powder to a low-pressure vessel for mixing the liquid with the powder, resulting in a mixed product; and
increasing the pressure of the mixed product by pumping the mixed product out from the low-pressure vessel.

12. The method according to claim 11, wherein feeding the flow of liquid and the amount of powder to the lower-pressure vessel further comprises lowering a pressure inside the vessel to less than atmospheric pressure.

13. The method according to claim 12, wherein lowering the pressure inside the vessel further comprises lowering the pressure inside the vessel to the steam pressure of water at a temperature range between the mixed product temperature and 10 degrees Celsius above the mixed product temperature.

14. The method according to claim 11, wherein providing a flow of liquid from a liquid supply system further comprises lowering a pressure of the liquid by at least 3.5 Bar.

15. The method of claim 11, wherein providing the flow of liquid further comprises deaerating the liquid.

16. The system of claim 1, wherein the deaeration system is configured to lower a pressure of the liquid by at least 3.5 Bar.

17. The system of claim 1, wherein the liquid inlet has a length between 2 m and 3 m.

18. The system of claim 1, wherein the deaeration system further comprises an intermediate tank.

19. The system of claim 18, wherein the deaeration system further comprises an exit pump configured to pump the liquid out of the liquid supply system and a vacuum pump configured to pump exhaust gases.

20. The system of claim 18, wherein the intermediate tank has a pressure close to but slightly higher than a boiling pressure of the liquid.
